(19) United States
(12) Patent Application Publication
(10) Pub. No.: US 2006/0085317 A1
(43) Pub. Date: Apr. 20, 2006

(54) Computer-based system and method for executing orders

(76) Inventor: Gregory Arthur Allen, Oakville (CA)

Correspondence Address: TORYS LLP, 79 WELLINGTON ST. WEST, SUITE 3000, TORONTO, ON, M5K 1N2, CA

(21) Appl. No.: 10/964,697

(22) Filed: Oct. 15, 2004

(51) Int. Cl. G06Q 40/00

(52) U.S. Cl. 705/37

(57) ABSTRACT

The present invention provides a novel system and method for executing orders. In an embodiment, a system for executing orders includes a communications gateway through which orders and intents can be passed to an internalization engine. The internalization is operable to maintain intents and compare them with incoming orders, and with market feeds of best bid offers, in order to match up certain incoming orders with intents from the same firm in accordance with market rules. Where no match is made, the order is passed to a trading engine, also connected to the communications gateway, so that the order can be processed in the usual manner. Where a match is made, an appropriate portion of the intent is paired with the order and a trade notification is sent to the trading engine for processing in the usual manner.

### FIELD OF THE INVENTION

The present invention relates to trading and more particularly relates to a computer-based method and system for executing orders.

### BACKGROUND OF THE INVENTION

Automated trading is offered in many different markets, and is a well known means of matching orders to buy and sell items in the market, and then executing those matched orders. One example of a market where automated trading is employed is an electronic stock exchange, such as the Toronto Stock Exchange (“TSX”).

In an electronic stock exchange, firms act on behalf of clients that are interested in buying or selling a security. (As used herein, the term “firm” refers to brokers, dealers, agents or the like.) The firm will interact with the electronic stock exchange via work stations where they place their orders to buy or sell securities on behalf of their clients. On execution of an order, a transaction fee is typically charged to the buying client and the selling client by both the buy-side firm and the sell-side firm. To reduce this fee, firms try to match their own buy and sell orders for the same security, so that the same firm is both on the sell side and buy side of a given trade. This process is called internalization. In this manner, the firm may reduce the overall fees that are incurred, given that there is a single firm involved with the trade. Internalization can also improve the liquidity of a particular security offered by a firm, and can also give the opportunity to provide price improvement.

Internalization is governed by many rules to ensure fairness—in particular to ensure that firms who are not using internalization do not get unfairly prevented from having their orders executed. For example, if a first firm posts an order at fair market value, and then a second firm attempts to set up an internalized trade between another, subsequent order and a preexisting order that are both being handled by the second firm, then in at least some jurisdictions market rules will ensure the first firm will be entitled to the attempted internalized trade and execute its order with the appropriate half of the attempted internalized trade. Other market rules apply to manage potential unfairness associated with the improved liquidity that can be offered by the firm that is making the internalized trades available. Still other market rules apply to manage potential unfairness created by price improvements offered by the firm that is making the internalized trades available. For Canada, examples of such rules are found in the proposed Universal Market Integrity Rules for Canadian Marketplaces promulgated by Regulation Services, (formerly TSE Regulation Services) dated Oct. 12, 2001, and in particular Appendix B, Rules 6.3 and 8.1, and Rules 5.2 and 5.3 thereof, the contents of which are incorporated herein by reference, a copy of which can be found at the website hosted by the Ontario Securities Commission, http://www.osc.gov.on.ca/MarketRegulation/SRO/rs/ro/sro-rs_chap13-1-3.pdf.

Such rules governing fairness must be respected when automating internalization. Indeed, it is known to automate internalization so that the firm does not need to manually match its own buy orders and sell orders. One example of known method for internalization is disclosed in U.S. patent application Ser. No.10/623,434, Publication Number US 2004/0024689, filed Jul. 17, 2003 entitled “System and Method for Automated Trading” to Zhou et al. Zhou discloses systems and methods for processing trade orders with improvement over the National Best Bid and Offer (“NBBO”) by internalizing certain orders. Zhou discloses an order router that receives orders from a firm, and also receives data from an algorithm engine that is itself connected to a market data feed. Of note is that the algorithm engine does not have access to the orders from the firm, and instead relies on the market data feed which is often seconds behind the actual order. As stated at Paragraph 46 of Zhou “It is important to note that broker-dealer 22 acting as a principal is not provided with access to information regarding the trade orders of broker-dealer 10 acting as an agent. This structure in which agency execution market data is separated from the algorithm engine enables the method and system to be used to internalize trade orders without raising concerns over misuse of customer market data and obtain improvement from the NBBO.” See also FIG. 1 of Zhou. A problem resulting from this structure is that it can be possible for the algorithm engine to forward an indication of interest (in this case, a bid/offer originating from the broker-dealer principal that has been processed by algorithm engine) with an insufficient improvement to the order router, since the data being used by the algorithm engine may be out of date by the time the intent reaches the order router. To address this problem, Zhou provides a secondary check, wherein the order router ultimately compares each intent with the NBBO Feed and, the order router will ultimately refuse to fulfill the intent with insufficient improvement against the order. The structure of the system in Zhou is thus emphasized as being critical in order to reduce concerns over misuse of customer market data, yet can result in the failure to fulfill certain intents.

Generally, it is also known to perform internalization on the brokerage side, wherein the firm maintains its own systems to attempt to find internal trades that can be made. One problem with this system is that there is invariably a delay from the market feed to the brokerage firm where the system is hosted, thereby creating the potential for out of date information to cause an illegal trade to be effected, and for valid opportunities to be missed. Additionally, many brokerage firms lack the infrastructure to consolidate all of their order flows from all of their locations in order to adequately seek out internalization opportunities.

Another example of a known method for automated internalization is disclosed in U.S. patent application Ser. No.10/307,506, Publication Number US 2003/0177086, filed Dec. 2, 2002 and entitled “Integrated Order Pre-Matching System” to Gomber et al. Gomber discloses a method for operating a computer system for processing orders in a security trading system that includes a reference market and a corresponding computer system. A message that indicates a quote is received. The quote includes quote parameters defining a buy limit order and a sell limit order. The quote parameters are stored. When an order is received it is determined whether the order matches the quote. If so, the order is executed against the quote. If not, the order data is forwarded to the reference market for execution in the usual manner. However, Gomber is directed to internalizations that are based on matching quotes with orders, which can be useful in environments where there are market makers, but is not more broadly applicable to environments where market makers do not exist or are not involved. A still further problem with Gomber is that the internalization system in Gomber is placed inside the trading engine, which can disadvantageously slow down the entire trading engine, thereby penalizing parties who are not interested in internalizing their trades and adding overall complexity to the trading engine. Yet a further problem is that, in order to implement the Gomber system, a securities market operating a existing trading engine would be faced with an overhaul of the entire existing trading engine, which may otherwise be functioning in a perfectly acceptable manner. Such an overhaul could, at least initially, run the risk of causing a failure of the entire trading engine as bugs and glitches are worked out of the overhauled trading engine.

### SUMMARY OF THE INVENTION

It is an object of the present invention to provide a novel computer-based system and method for executing orders that obviates or mitigates at least one of the above-identified disadvantages of the prior art.

According to an aspect of the invention, there is provided a computer-based system for executing orders comprising a communications gateway for receiving data representing orders, at least one intent and a market feed over at least one communication connection. The system also comprises a trading engine connected to the communications gateway for receiving and processing data records representing trading notifications. The system also comprises an internalization engine having a processor connected to the gateway for receiving the data representing the orders and the at least one intent. The processor is operable to perform a match of at least one of the orders with at least a portion the intent if the match accords with market rules when compared with the market feed. The processor is further operable to deliver data representing a trading notification thereof to the trading engine via the gateway for processing.

The processor can be operable to perform the match in less than about five hundred milliseconds. The processor can be operable to perform the match in less than about four hundred milliseconds. The processor can be operable to perform the match in less than about one hundred milliseconds.

The processor can be operable to perform the match if the at least one of the orders originates from a firm that is the same as a firm that generated the intent.

The processor can be operable to perform the match if the at least one order of the orders originates from a different firm that is different from a firm that generated the intent.

The market feed can include a market feed order matchable with the order then the processor only performs the match if a price improvement can be effected to the intent in order to improve over the market feed order.

The processor can be further operable to determine whether the match can be performed within a time period such that a substantial portion of quotes from the market feed remain valid within that time period.

The processor can be further operable to decline to perform the match if the time period exceeds a threshold in which a substantial portion of the quotes do not remain valid.

The time period can be chosen such that at least about ninety percent of the quotes remain valid.

The time period can be chosen such that at least about ninety-five percent of the quotes remain valid.

The time period can be chosen such that at least about 99.9 percent of the quotes remain valid.

Another aspect of the invention provides a computer-based internalization engine comprising an interface for connecting to a communication connection. The interface is for receiving orders, at least one intent and a market feed over the communication connection. The interface is also for connecting to a trading engine that is operable to receive and process trading notifications. The internalization engine also comprises a storage device connected to the interface for storing the at least one intent. The internalization engine also comprises an internalization processor connected to the interface and the storage device. The internalization processor is operable to perform a match of at least one of the orders with at least a portion of the intent if the match accords with market rules and when compared with the market feed. The internalization engine is further operable to deliver a trading notification thereof to the trading engine for processing.

Another aspect of the invention provides a computer-based method of executing orders in the internalization engine, the method comprising the steps of:
receiving an intent at the internalization engine and storing the intent in a storage device;
receiving a regular order at an internalization processor;
in the internalization processor, determining if at least a portion of the intent matches the regular order and;
if the regular order does not match then forwarding the regular order to a trading engine;
   if the regular order does match then determining if the intent conflicts with a quote received over a market feed connected to the internalization processor and;
      if the intent does not conflict with the market feed then forwarding a trade notification to the trading engine instructing the trading engine to execute a trade between the order and a relevant portion of the intent according to the match;
      if the intent conflicts with the market feed then determining if the intent can be adjusted to improve over the market feed;
         if the intent cannot be adjusted to improve over the market feed then forwarding the regular order to the trading engine;
         if the intent can be adjusted to improve over the market feed then performing such adjustment and then forwarding a trade notification to the trading engine instructing the trading engine to execute a trade between the order and a relevant portion of the adjusted intent according to the match.
The method can comprise the additional step of repeating the steps therein until the intent is fulfilled.
Another aspect of the invention provides a computer-readable medium containing a set of programming instructions for a general purpose computer, the set of programming instructions including a computer-based method of executing orders in an internalization engine, the method comprising the steps of:
receiving an intent at the internalization engine and storing the intent in a storage device;
receiving a regular order at an internalization processor;
in the internalization processor, determining if at least a portion of the intent matches the regular order and;
   if the regular order does not match then forwarding the regular order to a trading engine;
   if the regular order does match then determining if the intent conflicts with a quote received over a market feed connected to the internalization processor and;
      if the intent does not conflict with the market feed then forwarding a trade notification to the trading engine instructing the trading engine to execute a trade between the order and a relevant portion of the intent according to the match;
      if the intent conflicts with the market feed then determining if the intent can be adjusted to improve over the market feed;
         if the intent cannot be adjusted to improve over the market feed then forwarding the regular order to the trading engine;
   if the intent can be adjusted to improve over the market feed then performing such adjustment and then forwarding a trade notification to the trading engine instructing the trading engine to execute a trade between the order and a relevant portion of the adjusted intent according to the match.

### BRIEF DESCRIPTION OF THE DRAWINGS

The invention will now be described by way of example only, and with reference to the accompanying drawings, in which:

FIG. 1 is a schematic representation of a system for executing orders in accordance with an embodiment of the invention;

FIG. 2 shows a flow-chart depicting a method for processing requests in accordance with another embodiment of the invention;

FIG. 3 shows the system of FIG. 1 having certain assumptions made thereabout to assist in the explanation of the method of FIG. 2;

FIG. 4 shows the system of FIG. 3 during the performance of certain steps of method 200;

FIG. 5 shows the system of FIG. 3 during the performance of certain steps of method 200;

FIG. 6 shows the system of FIG. 3 during the performance of certain steps of method 200;

FIG. 7 shows the system of FIG. 3 during the performance of certain steps of method 200;

FIG. 8 shows the system of FIG. 3 during the performance of certain steps of method 200;

FIG. 9 shows the system of FIG. 3 during the performance of certain steps of method 200;

FIG. 10 shows the system of FIG. 3 during the performance of certain steps of method 200; and, FIG. 11 shows the system of FIG. 3 during the performance of certain steps of method 200; and.

FIG. 12 is a schematic representation of a system for executing orders in accordance with another embodiment of the invention.

### DETAILED DESCRIPTION OF THE INVENTION

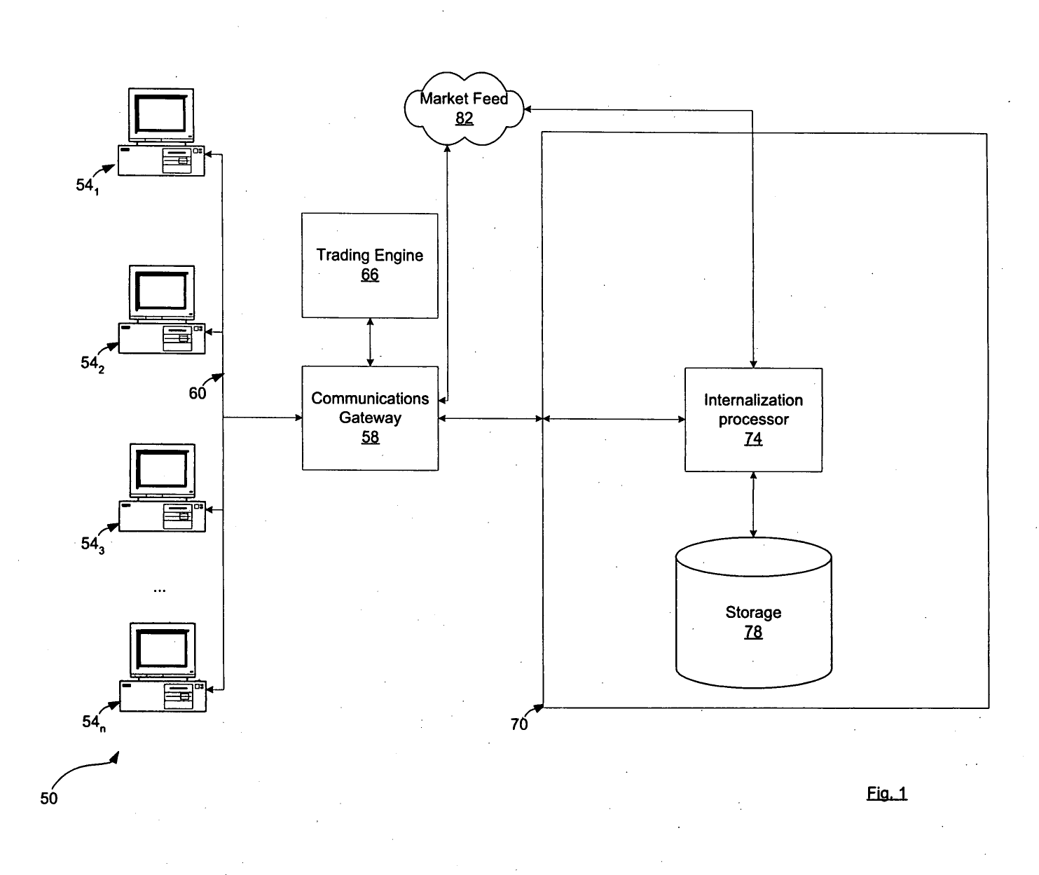

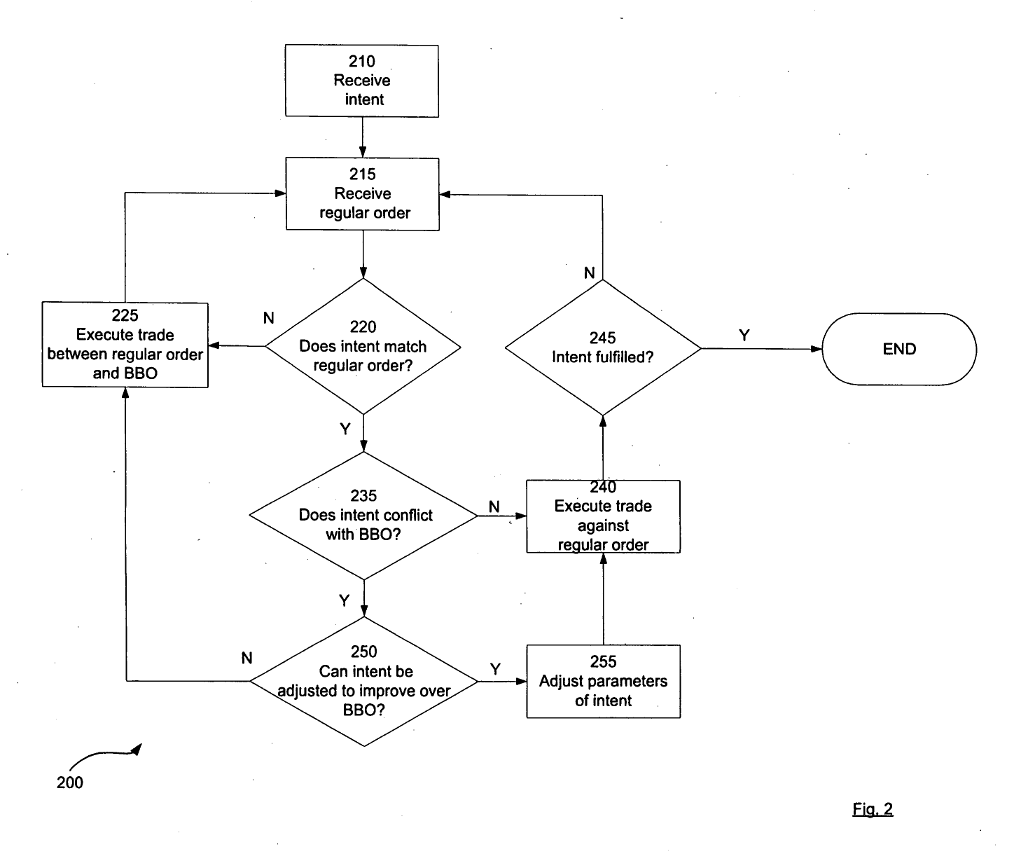

Referring now to FIG. 1, a system for executing orders is indicated generally at 50. System 50 comprises a plurality of workstations 54₁, 54₂ . . . 54ₙ (generically referred to herein as “workstation 54” and collectively as “workstations 54”) all of which are connected to a market communications gateway 58 via any suitable connection 60.

Each workstation 54 is typically a computing device such as a personal computer having a keyboard and mouse (or other input devices), a monitor (or other output device) and a desktop-module connecting the keyboard, mouse and monitor and housing one or more central processing units, volatile memory (i.e. random access memory), persistent memory (i.e. hard disk devices) and network interfaces to allow the workstation 54 to communicate over connection 60. However, it is to be understood that workstation 54 can be any type of computing device, such as a personal digital assistant, cell phone, laptop computer, email paging device etc. Each workstation 54 is operated by a trader belonging to a firm, or a group of workstations 54 may be operated by a plurality of traders belonging to one firm. Each workstation 54 is used to enter orders to buy or sell a particular security.

Communications gateway 58 is a server, a mainframe, or other type of computing environment that is operable to receive orders from workstations 54. For example, communications gateway 58 can be a Sun Fire V480 running a UNIX operating system, from Sun Microsystems, Inc. of Palo Alto Calif., and having four central processing units each operating at about 900 megahertz and having about sixteen gigabytes of random access memory. However, it is to be emphasized that this particular server is merely exemplary, a vast array of other types of computing environments for communications gateway 58 are within the scope of the invention.

In a present embodiment, communications gateway 58 is part of an on-line trading system, and is thus able to process buy orders and sell orders that include requests to purchase, sell, cancel etc. securities that can be traded on-line. Communications gateway 58 is connected to a primary persistent storage (not shown) that maintains all persistent data associated with the orders and processing thereof for communications gateway 58. Communications gateway 58 is also operable to apply time stamps to orders as they are received by accessing time-date information from the operating system of gateway 58. Communications gateway 58 is operable to route orders according to the stock market ID, or firm ID to a trading engine 66 also attached to communications gateway 58. Trading engine 66 is operable to maintain a central matching engine, where buy orders and sell orders are executed against each other, and against a central repository of orders to thereby process the trading of securities. In general, trading engine 66 is operable to execute orders in the usual manner, and return the results of those executed orders to the workstations 54 that originated the buy order and the sell order.

Connection 60 can be wired or wireless, or based on combinations thereof, and based on any type of known network architecture or platform, (e.g. the Internet or a wide area network) or combinations thereof.

Communications gateway 58 is also operable to forward intent orders received from workstations 54 to an internalization engine 70 for further processing. As used herein, the term intent refers to a message where the firm has requested internalization. Internalization engine 70 is also server, a mainframe, or other type of computing environment. For example, internalization engine 70 can be a Sun 480R server from Sun Microsystems, Inc. of Palo Alto Calif., which has four CPUs and, because a significant portion of processing is performed in random access memory, such a server should be configured with about eight to about sixteen gigabytes of random access memory.. However, it is to be emphasized that this particular server is merely exemplary, a vast array of other types of computing environments for internalization engine 70 are within the scope of the invention. Whichever computing environment is chosen, internalization engine 70 is operable to process intents, looking for matches with regular orders, and sending trade notifications to trading engine 66 for reporting to market participants in the usual manner, or forwarding unmatched orders to trading engine 66. Thus, within the chosen computing environment, internalization engine 70 includes at least a processor 74 and a storage device 78. Storage device 78 is operable to receive and store at least one intent, while processor 74 is operable to match those intents with regular orders, if possible, as those regular orders are received. Processor 74 is also connected to a market feed 82, wherein processor 74 is able to access a best bid-offer (“BBO”) for any given security being traded using system 50. Further detail about internalization engine 70 will be provided below.

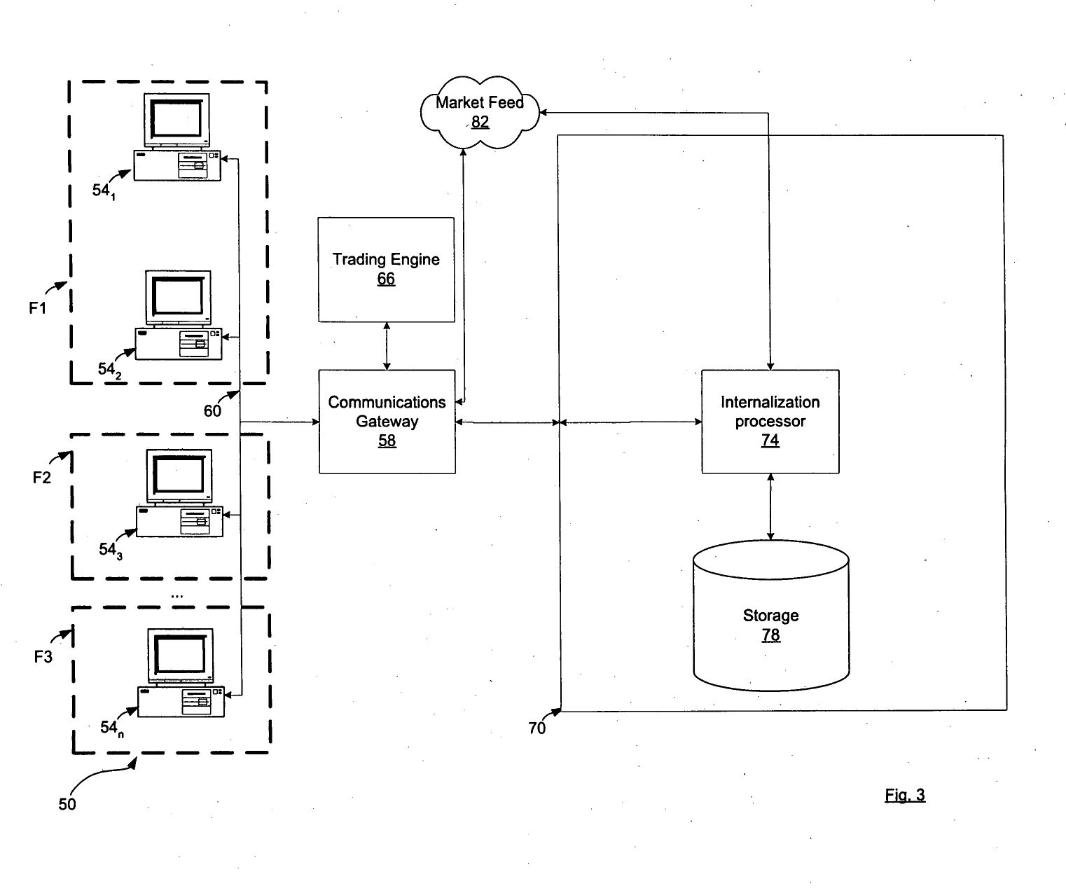

Referring now to FIG. 2, a method for executing orders in accordance with another embodiment of the invention is indicated generally at 200. In order to assist in the explanation of the method, it will be assumed that method 200 is operated using system 50. Furthermore, the following discussion of method 200 will lead to further understanding of system 50 and its various components. However, it is to be understood that system 50 and/or method 200 can be varied, and need not work exactly as discussed herein in conjunction with each other, and that such variations are within the scope of the present invention.

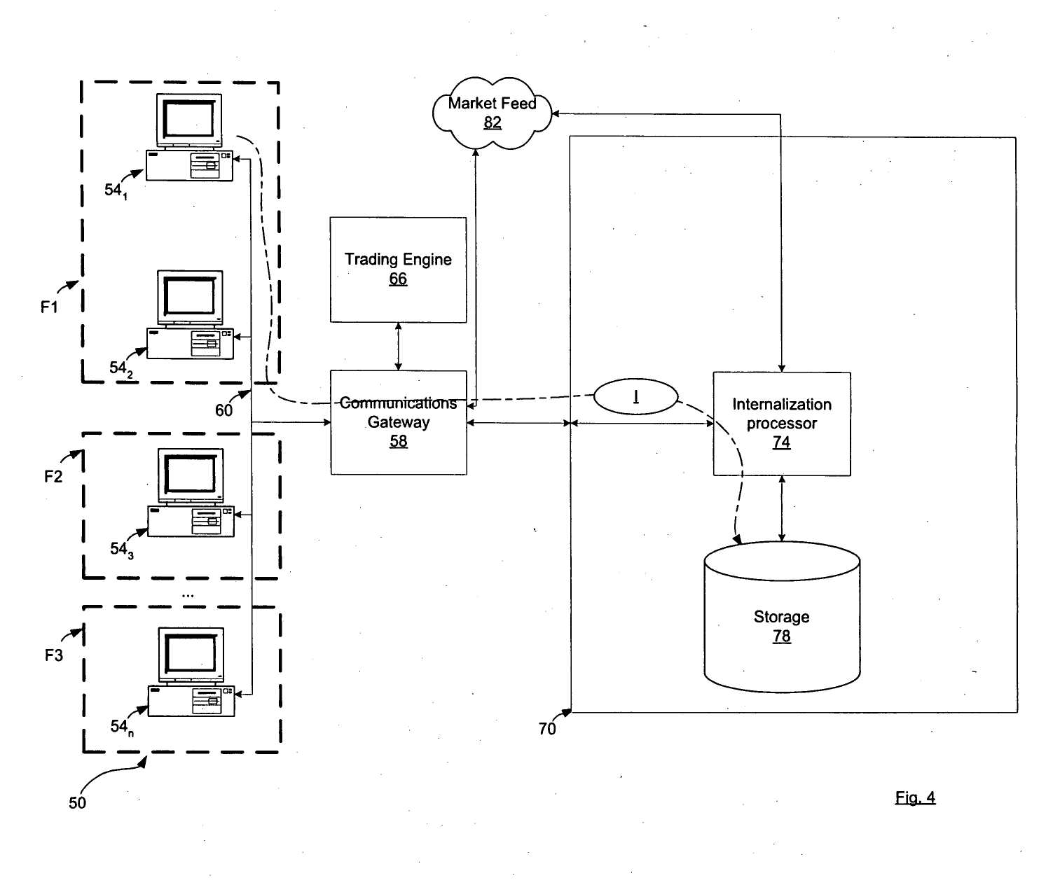

Having introduced method 200, certain assumptions about system 50 will be made in order to facilitate the explanation of method 200. Accordingly, a specialized version of system 50 is shown in FIG. 3 that reflects these assumptions. In particular, it will be assumed that workstation 54₁ and workstation 54₂ are owned and operated by a first firm denoted by reference F1. Workstation 54₁ and workstation 54₂ are typically located in remote locations from the other such that the operator of workstation 54₁ is not aware of, or need not be aware of, the trading being performed by the operator (i.e. trader) of workstation 54₂. For example “remote locations” can mean that each workstation 54₁ and workstation 54₂ is located in a different city, or on different floors of the same building belonging to a single firm. While in the present example such locations are remote from the other, it is contemplated that workstation 54₁ and workstation 54₂ can be located proximal to each other, but that the operator of workstation 54₁ is not aware of, or need not be aware of, the trading being performed by the operator of workstation 54₂. In general, it is to be understood that workstation 54₁ and workstation 54₂ are owned by a single firm F1, and thus that the respective operators of workstation 54₁ and workstation 54₂ may desire to internalize trades with each other rather than effecting trades with other firms. By the same token, it is assumed that workstation 54₃ and workstation 54₁ are owned by a second firm and a third firm, denoted in FIG. 3 by references F2 and F3, respectively. Firms F2 and F3 would typically not desire to internalize a trade with the operators of workstation 54₁ and workstation 54₂. (However, in other embodiments it is contemplated that a version of the “internalization” discussed in the present embodiment could be offered between firms, such as between firms F1 and F3, to provide inter-broker internalized trades.)

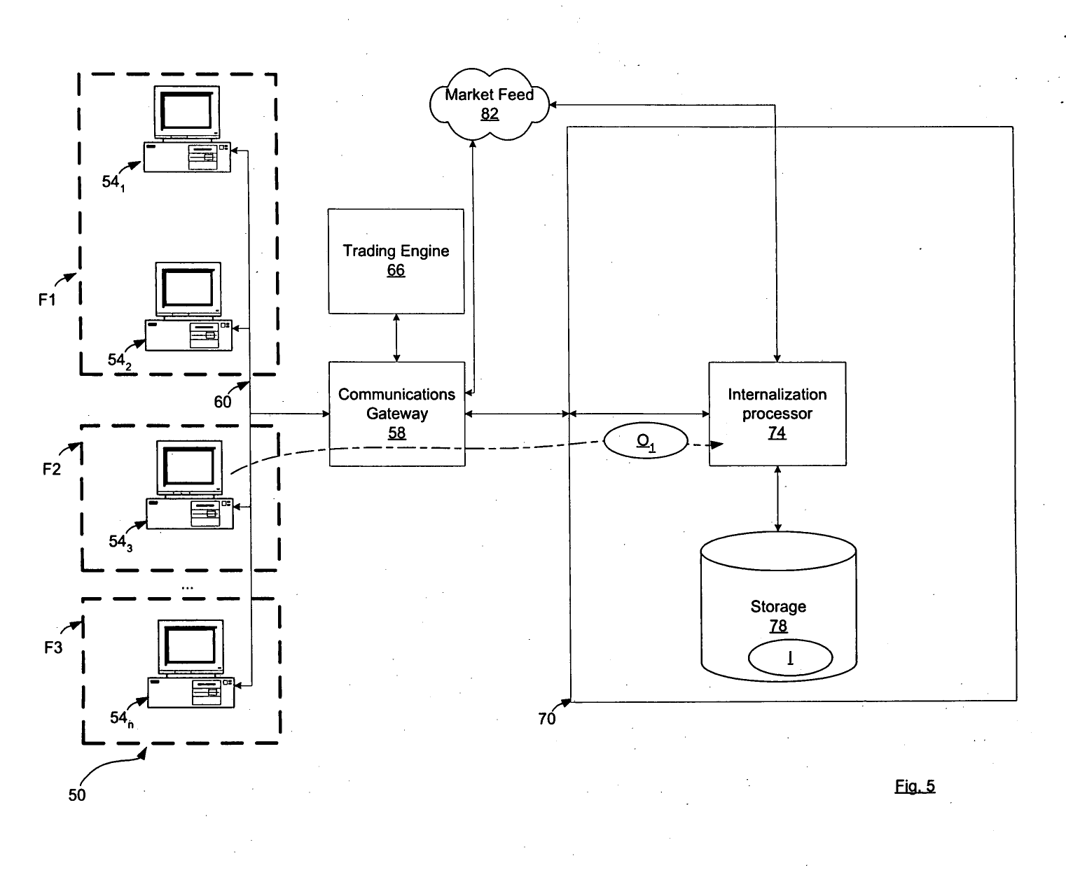

Having identified certain assumptions to be made about system 50 to assist in the explanation of method 200, reference will now be made again to method 200 in FIG. 2. Beginning first at step 210, an intent is received. As used herein the term intent refers to a message that indicates a desire to trade in a particular quantity of a given security, at a given price, etc. provided that the other side of such a trade comes from the same brokerage firm that initiated the intent. By way of example, assume that the operator (i.e. trader) of workstation 54₁ of firm F1 wishes to lodge an intent for processing by internalization engine 70. This example is shown in FIG. 4, wherein an intent, represented as an oval and indicated at reference “I”, is shown as entered at workstation 54₁ and received at internalization processor 74, (via communications gateway 58, which applies appropriate time stamps to Intent I as Intent I is passed through gateway 58), and stored on storage device 78. Table I shows the structure and exemplary contents of intent I.

TABLE I
Intent I

| Field Number | Field Name | Example Contents |
|---|---|---|
| 1 | Firm | Firm F1 |
| 2 | Security Name | XYZ Co. |
| 3 | Transaction Type | Buy |
| 4 | Quantity | 10,000 units |
| 5 | Price per unit | $1.00 |
| 6 | Improvement Criterion | 5 cents |

More particularly, Field 1 of Table I, named “Firm” identifies that the originating firm of Intent I is Firm F1, and thereby indicates that Firm F1 wishes to match one or more orders associated with Intent I with corresponding orders also originating from Firm F1. Field 2 of Table I, named “Security Name” identifies the name of the specific security that is the subject of the internalized trade—in this example, “XYZ Co.”. Field 3 of Table I, named “Transaction Type” identifies whether the intent is an intent to buy, sell, etc. the security identified in Field 2. In this example, the Transaction Type is “Buy”, indicating that there is an intent to trade with corresponding orders to sell (Other Transaction Types could include short selling, etc.). Field 4 of Table I, named “Quantity” identifies the desired quantity of the security—in the present example, the Quantity is “10,000 units”, indicating that the intention is to Buy 10,000 units of XYZ Co. Field 5 of Table I, named “Price per unit” indicates the desired limit price at which the security is to be traded. In the present example, the Price per Unit is $1.00. Finally, Field 6 of Table I, named “Improvement Criterion” indicates the amount by which an incoming order can be price-improved to make a desired trade valid in light of market rules. In the present example, the criterion is “5 cents”, indicating that the price per unit can be increased by five cents in order to effect the trade, however in no event can the price per unit exceed the Price per Unit limit price of $1.00 set in Field 5. (Note that in the present embodiments, Field 6, Improvement Criterion is included to facilitate explanation of the present embodiment, but that in another embodiment, discussed below, Improvement Criterion can be fixed by the operator of internalization processor 74 to a particular amount, such as one cent, or other minimum or other amount that would be desired to achieve suitable price improvement. In still other embodiments, such Improvement Criterion could actually be based on a plurality of different criteria, and not simply be tied to the price.)

While not required, it can be desired at this point to perform a number of validations. For example, if intent I is received after market close, then intent I can be rejected as being invalid simply for having been received at an unacceptable time. Other validations can include the verification of a) the existence of the security in question; b) whether the price and improvement combination is within a reasonable range of the BBO on the market feed 82. Other validations will now occur to those of skill in the art. If such validations are performed, but not met, then method 200 can be immediately ended, and the intent I can be rejected back to the originator.

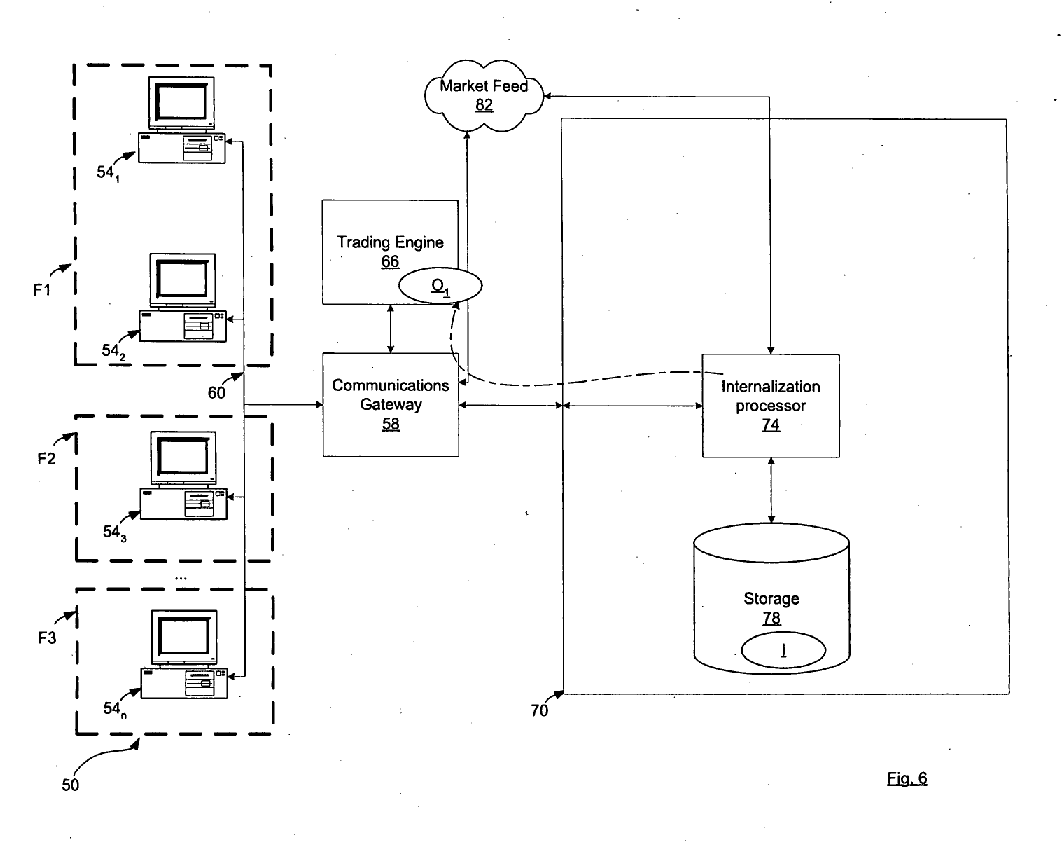

Assuming, however, that intent I is validly received at step 210, then method 200 advances to step 215. At step 215, a regular order is received. As used herein the term regular order refers to a message that indicates a desire to trade in a particular quantity of a given security, at a given price, as such messages normally appear in order to perform a trade. Continuing with the example associated with Intent I above, assume that the operator of workstation 54₃ of firm F2 wishes to enter an order. This example is shown in FIG. 5, wherein a first order, represented as an oval and indicated at reference “O₁”, is shown as entered at workstation 54₃ and received at internalization processor 74 via communications gateway 58, which applies appropriate time stamps to Order O₁ as Order O₁ is passed through gateway 58. Table II shows the structure and exemplary contents of Order O₁.

TABLE II
Order O₁

| Field Number | Field Name | Example Contents |
|---|---|---|
| 1 | Firm | Firm F2 |
| 2 | Security Name | ABC Co. |
| 3 | Transaction Type | Buy |
| 4 | Quantity | 1,000 units |
| 5 | Price per unit | $1.99 |

More particularly, Field 1 of Table II, named “Firm” identifies that the originating firm of Order O₁ is Firm F2. Field 2 of Table II, named “Security Name” identifies the name of the specific security that is the subject of the trade—in this example, “ABC Co.”. Field 3 of Table II, named “Transaction Type” identifies whether the order is to buy, sell, etc. the security identified in Field 2. In this example, the Transaction Type is “Buy”, indicating that this is an order to buy. Field 4 of Table II, named “Quantity” identifies the desired quantity of the security—in the present example, the Quantity is “1,000 units”, indicating that the intention is to Buy 1,000 units of ABC Co. Field 5 of Table II, named “Price per unit” indicates the desired price at which the security is to be traded. In the present example, the Price per Unit is $1.99. While Field 5 of Table II in the present embodiment is a Price per unit, which is essentially a limit order, in other embodiments this field could simply indicate that the order is going to be a market order, in that the price of the order will be based on whatever the current market price is for the Security in Field 2.

At step 220, a determination is made as to whether the intent received at step 210 matches the order received at step 215. Continuing with the specific example, such a match-attempt is made by internalization processor 74, which examines the contents of both Intent I and Order O₁ to see if various fields match to indicate the possibility of an internalization being effected. Table III reproduces Tables I and II side-by-side to assist in explaining this specific example.

TABLE III
Comparison of Intent I and Order O₁

| Table I | | | Table II | | |
|---|---|---|---|---|---|
| Intent I | | | Order O₁ | | |
| Field | | Example | Field | | Example |
| Number | Field Name | Contents | Number | Field Name | Contents |
| 1 | Firm | Firm F1 | 1 | Firm | Firm F2 |
| 2 | Security | XYZ Co. | 2 | Security | ABC Co. |
| | Name | | | Name | |
| 3 | Transaction | Buy | 3 | Transaction | Buy |
| | Type | | | Type | |
| 4 | Quantity | 10,000 | 4 | Quantity | 1,000 |
| | | units | | | units |
| 5 | Price per | $1.00 | 5 | Price per | $1.99 |
| | unit | | | unit | |
| 6 | Improvement | 5 cents | | | |
| | Criterion | | | | |

Thus, at step 220, internalization processor 74 examines Intent I and Order O₁ for matches between Fields 1 and 2, and for complementary matches between Field 3. More specifically, internalization processor 74 determines whether the firms F associated with Intent I and Order O₁ match. Without a match, internalization is not possible, and therefore it would be determined at step 220 that “no”, there is no match between Intent I and Order O₁ and so method 200 would advance to step 225. As can be seen in Table III, Intent I originates from Firm F1 while Order O₁ originates from Firm F2 and thus Order O₁ does not match Intent I and is therefore unsuitable for internalization, and so method 200 would advance to step 225.

(A review of Table III also demonstrates a lack of match in other fields as well, and thus even if both the Firms F were the same, a match would still not exist at step 220. In particular, Field 2 of Tables I and II differ, with Table I specifying XYZ Co., and with Table II specifying ABC Co. Also, Field 3 of Table I specifies a “Buy”, and therefore Field 3 of Table II would need to specify “Sell” in order for a match to exist).

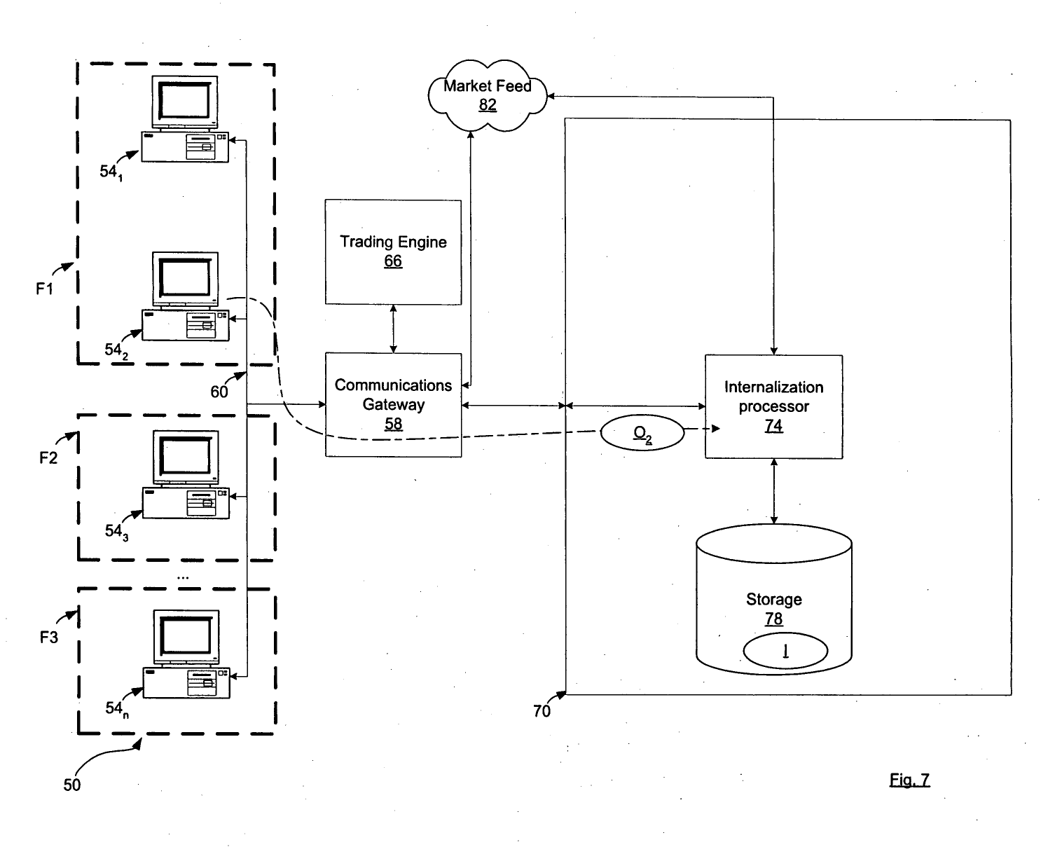

In any event, regardless of the criteria used at step 220 that ultimately determines there is no match between the intent received at step 210 and the order received at step 215, method 200 will advance to step 225 at which point the Order O₁ will be forwarded to the trading engine 66 for handling in the usual manner. Step 225 is represented in FIG. 6, as Order O₁ is routed to trading engine 66.

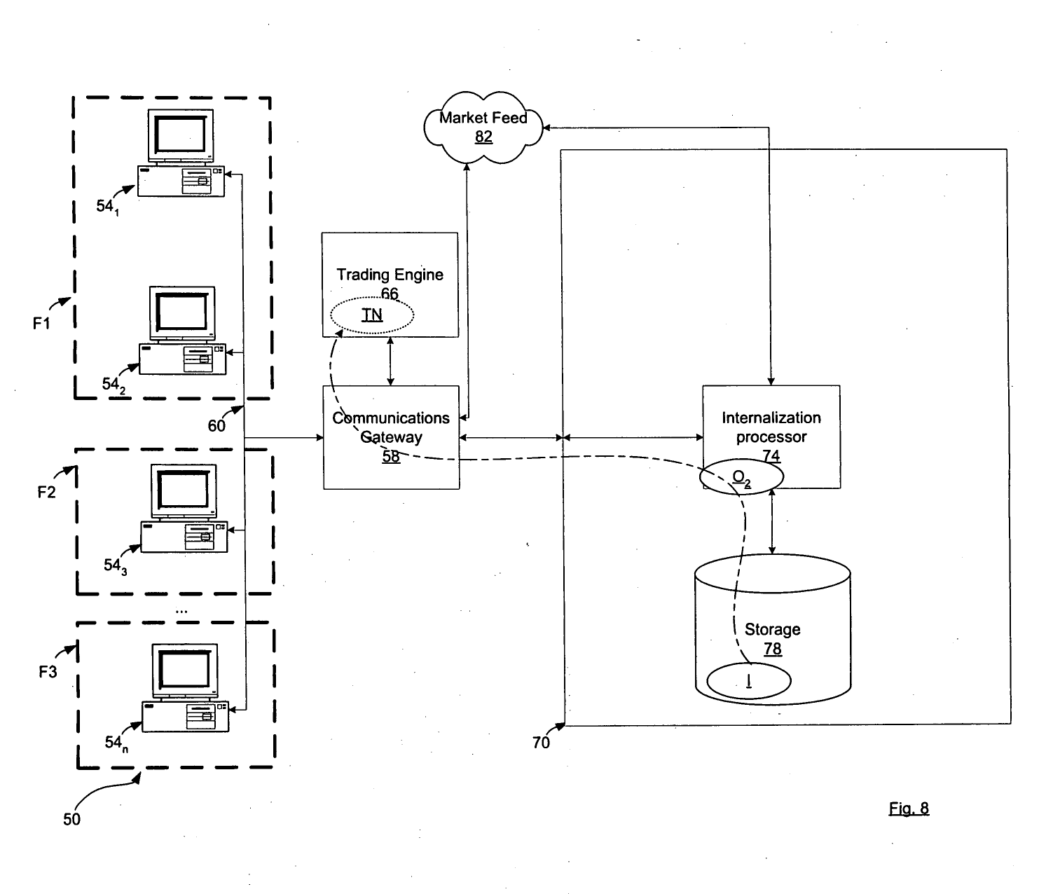

After step 225, method 200 cycles back to step 215 where another regular order is received. During this pass through step 215, it will be assumed a second order 02 is received, as represented in FIG. 7. Order O₂ is shown as entered at workstation 54₂ and received at internalization processor 74 via communications gateway gateway 58, which applies appropriate time stamps to Order O₂ as Order O₂ is passed through gateway 58. Table IV shows the structure and exemplary contents of Order O₂.

TABLE IV
Order O₂

| Field Number | Field Name | Example Contents |
|---|---|---|
| 1 | Firm | Firm F1 |
| 2 | Security Name | XYZ Co. |
| 3 | Transaction Type | Sell |
| 4 | Quantity | 5,000 units |
| 5 | Price per unit | $1.00 |

Returning again to step 220, a determination is made as to whether the intent received at step 210 matches the order just received at step 215. Continuing with the specific example, such a match is made by internalization processor 74, which examines the contents of both Intent I and Order O₂ to see if various fields match to indicate the possibility of an internalization being effected. Table V reproduces Tables I and IV side-by-side to assist in explaining this specific example.

TABLE V
Comparison of Intent I and Order O₂

| Table I | | | Table IV | | |
|---|---|---|---|---|---|
| Intent I | | | Order O₂ | | |
| Field | | Example | Field | | Example |
| Number | Field Name | Contents | Number | Field Name | Contents |
| 1 | Firm | Firm F1 | 1 | Firm | Firm F1 |
| 2 | Security | XYZ Co. | 2 | Security | XYZ Co. |
| | Name | | | Name | |
| 3 | Transaction | Buy | 3 | Transaction | Sell |
| | Type | | | Type | |
| 4 | Quantity | 10,000 | 4 | Quantity | 5,000 |
| | | units | | | units |
| 5 | Price per | $1.00 | 5 | Price per | $1.00 |
| | unit | | | unit | |
| 6 | Improvement | 5 cents | | | |
| | Criterion | | | | |

Thus, at step 220, internalization processor 74 examines Intent I and Order O₂ for matches between Fields 1 and 2, and for complementary matches between Field 3. More specifically, internalization processor 74 determines whether the firms F associated with Intent I and Order O₂ match. Since Intent I and Order O₂ both originated from Firm F1, and since the Security Name is “XYZ Co.” for Intent I and Order O₂, and since Intent I is a “Buy” while Order O₂ is a “Sell”, it will be determined at step 220 that “yes”, Intent I does match Order O₂, and thus method 200 will advance to step 235.

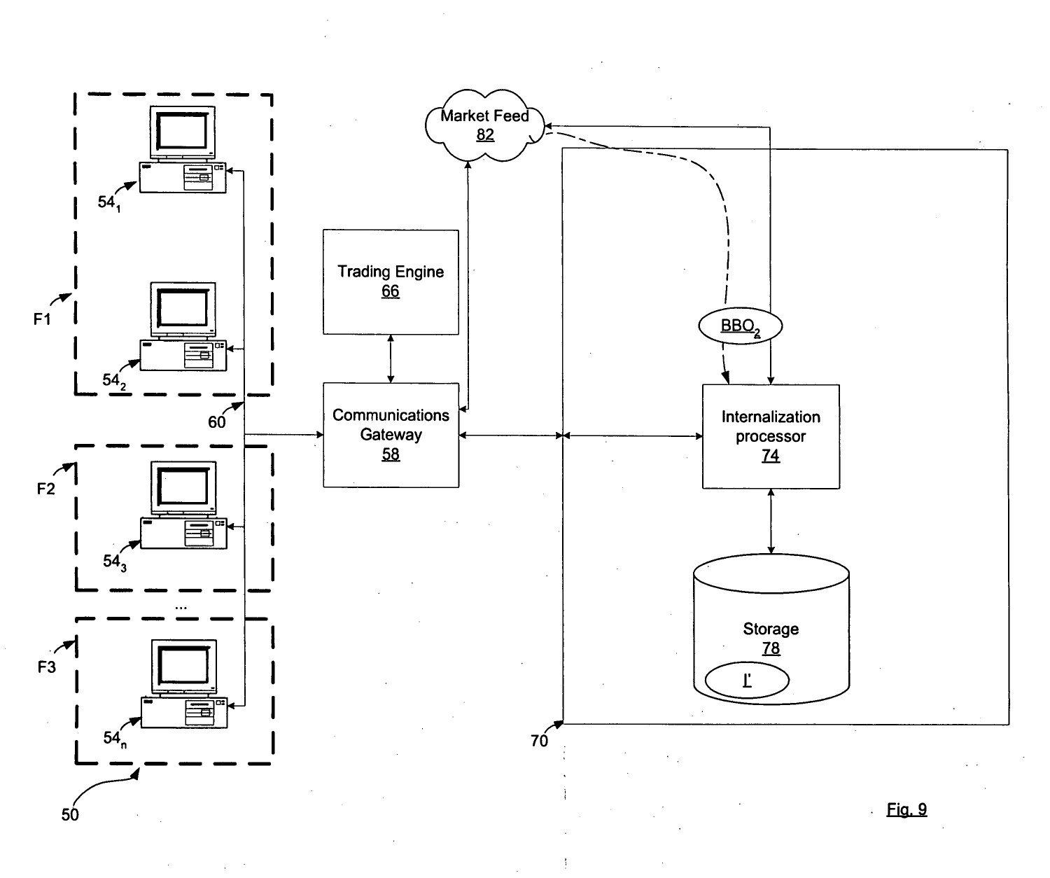

At step 235, a determination is made as to whether matching intent I with Order O₂ would conflict with any market rules, or would match with an outstanding BBO order as indicated by market feed 82. Assuming that there is no conflict (i.e. there are no outstanding BBO orders that could be matched with Order O₂), then method 200 will advance to step 240, at which point a trade will be executed between Intent I and Order O₂. This step is represented in FIG. 8, as internalization processor 74 passes a trade notification TN to trading engine 66 for trade notification, so that the trade can be recorded and interested parties notified, including the originator of Intent I and the originator of Order O₂. Table VI shows the form in which the trade notification TN is presented to trading engine 66. Trading engine 66 can then handle the trade notification TN in the usual manner, returning results to Firm F1, allowing Firm F1 (and/or the entities that placed Intent I and Order O₂) to enjoy the benefits of an internalized trade.

TABLE VI
Information for trade at trading engine
66 regarding trade notification TN

| Portion of trade | | | Portion of trade | | |
|---|---|---|---|---|---|
| notification TN | | | notification TN | | |
| extracted from Intent I | | | From Order O₂ | | |
| Field | | Example | Field | | Example |
| Number | Field Name | Contents | Number | Field Name | Contents |
| 1 | Firm | Firm F1 | 1 | Firm | Firm F1 |
| 2 | Security | XYZ Co. | 2 | Security | XYZ Co. |
| | Name | | | Name | |
| 3 | Transaction | Buy | 3 | Transaction | Sell |
| | Type | | | Type | |
| 4 | Quantity | 5,000 | 4 | Quantity | 5,000 |
| | | units | | | units |
| 5 | Price per | $1.00 | 5 | Price per | $1.00 |
| | unit | | | unit | |

Also as part of step 240, Intent I is updated to generate Intent I′, which reflects a reduced Quantity according to the portion of Intent I fulfilled by Order O₂. Table VII shows Intent I′ after having been updated

TABLE VII
Intent I′
(after a portion of Intent I is fulfilled against Order O₂)

| Field Number | Field Name | Example Contents |
|---|---|---|
| 1 | Firm | Firm F1 |
| 2 | Security Name | XYZ Co. |
| 3 | Transaction Type | Buy |
| 4 | Quantity | 5,000 units |
| 5 | Price per unit | $1.00 |
| 6 | Improvement Criterion | 5 cents |

Method 200 then advances to step 245, at which point a determination is made as to whether the intent received at step 210 has been fulfilled. If yes, then method 200 ends, and if not, method 200 returns to step 215 to await new regular orders against which intent I′ may be fulfilled.

In the present example, since intent I′ still has an outstanding intention to buy five-thousand more units of XYZ Co, it will be determined at step 245 that the intent is not fulfilled and method 200 returns to step 215.

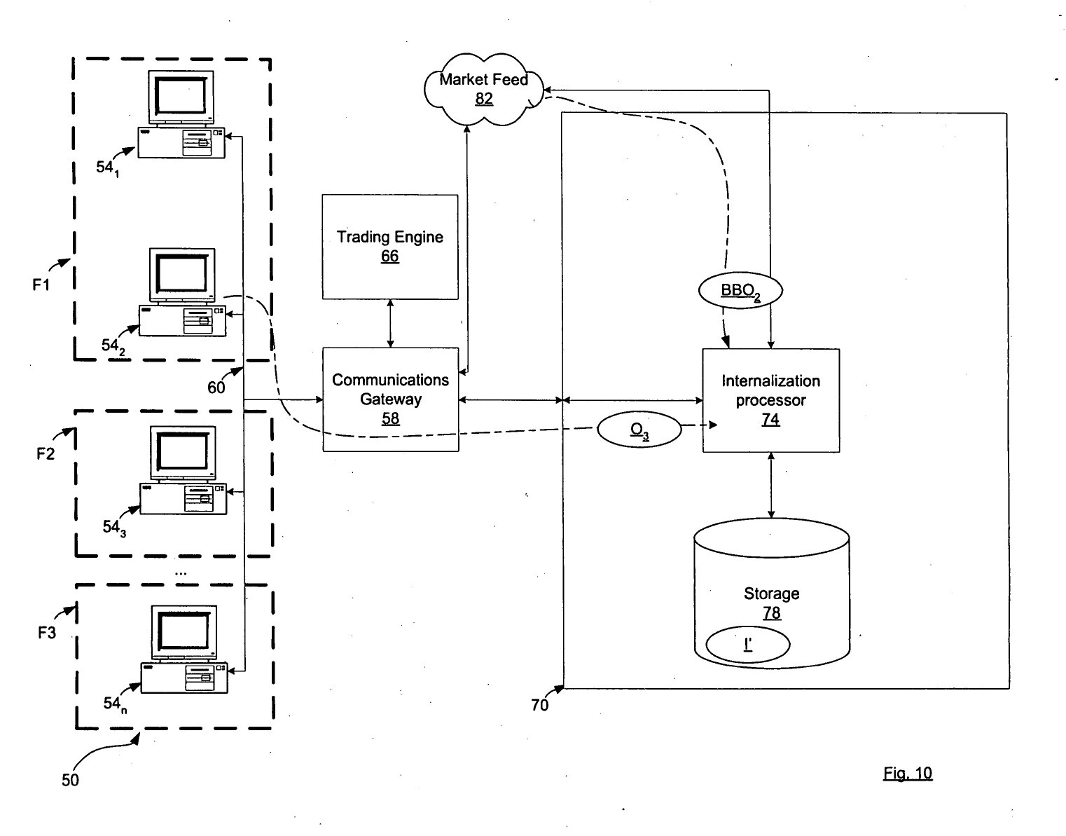

Continuing with this example, prior to the performance of step 215 it will be assumed that market feed 82 indicates Order BBO₂ available, shown in Table VIII, and represented in FIG. 9. It should be understood that in FIG. 9, the information associated with Order BBO₂ is simply available to internalization processor 74, but the order itself is not actually being passed to internalization processor 74 for trading.

TABLE VIII
BBO Order BBO₂

| Field Number | Field Name | Example Contents |
|---|---|---|
| 1 | Firm | Firm F3 |
| 2 | Security Name | XYZ Co. |
| 3 | Transaction Type | Buy |
| 4 | Quantity | 5,000 units |
| 5 | Price per unit | $0.99 |

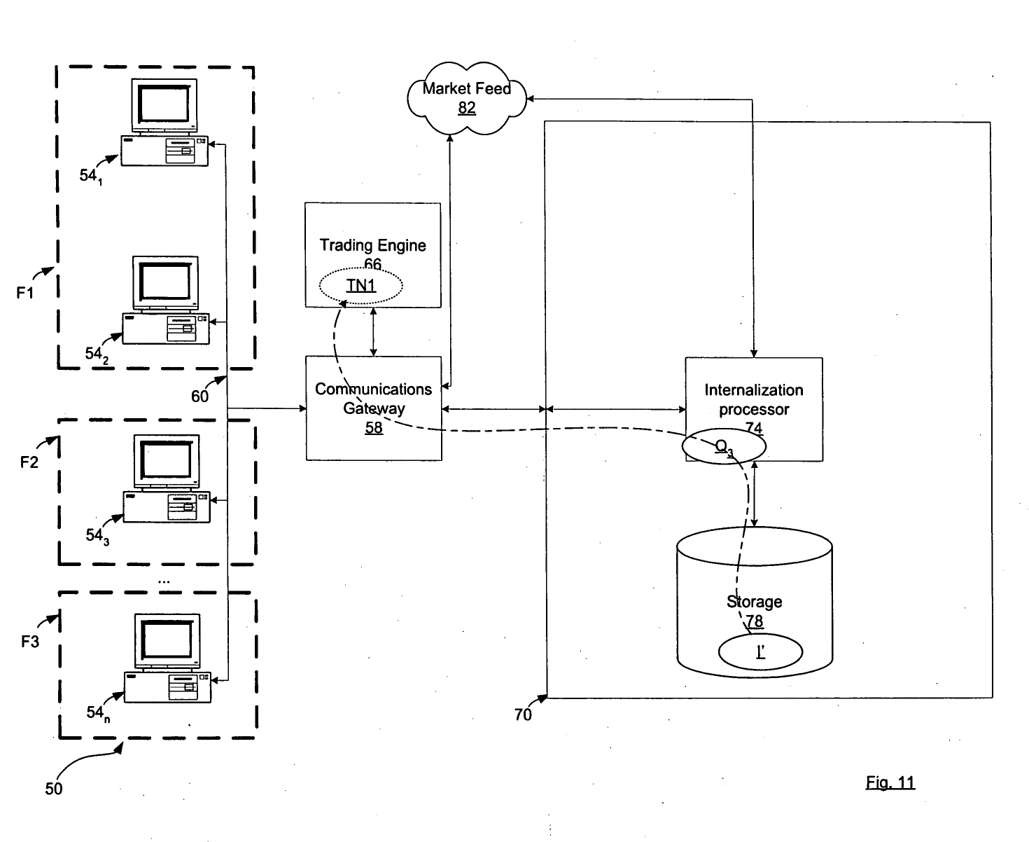

During this pass through step 215, it will be assumed a third order O₃ is received, as represented in FIG. 10. Order O₃ is shown as entered at workstation 54₂ and received at initialization processor 74 via communications gateway 58, which applies appropriate stamps to Order O₃ as Order O₃ is passed through gateway 58. Table IX shows the structure and exemplary contents of Order O₃.

TABLE IX
Order O₃

| Field Number | Field Name | Example Contents |
|---|---|---|
| 1 | Firm | Firm F1 |
| 2 | Security Name | XYZ Co. |
| 3 | Transaction Type | Sell |
| 4 | Quantity | 5,000 units |
| 5 | Price per unit | $0.95 |

Returning again to step 220, a determination is made as to whether the intent received at step 210 matches the order just received at step 215. Continuing with the specific example, such a match is made by internalization processor 74, which examines the contents of both Intent I′ and Order O₃ to see if various fields match to indicate the possibility of a internalization being effected. Table X reproduces Tables VII and IX side-by-side to assist in explaining this specific example.

TABLE X
Comparison of Intent I and Order O₃

| Table VII | | | Table IX | | |
|---|---|---|---|---|---|
| Intent I′ | | | Order O₃ | | |
| Field | | Example | Field | | Example |
| Number | Field Name | Contents | Number | Field Name | Contents |
| 1 | Firm | Firm F1 | 1 | Firm | Firm F1 |
| 2 | Security | XYZ Co. | 2 | Security | XYZ Co. |
| | Name | | | Name | |
| 3 | Transaction | Buy | 3 | Transaction | Sell |
| | Type | | | Type | |
| 4 | Quantity | 5,000 | 4 | Quantity | 5,000 |
| | | units | | | units |
| 5 | Price per | $1.00 | 5 | Price per | $0.95 |
| | unit | | | unit | |
| 6 | Improvement | 5 cents | | | |
| | Criterion | | | | |

Thus, at step 220, internalization processor 74 examines Intent I and Order O₃ for matches between Fields 1 and 2, and for complementary matches between Field 3. More specifically, internalization processor 74 determines whether the firms F associated with Intent I′ and Order O₃ match. Since Intent I′ and Order O₃ both originated from Firm F1, and since the Security Name is “XYZ Co.” for Intent I′ and Order O₃, and since Intent I′ is a “Buy” while Order O₃ is a “Sell”, it will be determined at step 220 that “yes”, Intent I′ does match Order O₃, and thus method 200 will advance to step 235.

At step 235, a determination is made as to whether matching intent I′ with Order O₃ would conflict with outstanding BBO order BBO₂ indicated from market feed 82. Due to the existence of BBO Order BBO₂, during this pass through step 235 it would be determined “Yes”, a conflict does exist, in particular because the price per unit being bid in BBO₂ is four cents higher than the price per unit being offered in Order O₃.

At this point, method 200 advances from step 235 to step 250, where a determination is made as to whether the intent can be adjusted to improve over the outstanding BBO order. Since the Improvement Criterion for Intent I′ (i.e. Field 6 of Table VII) indicates that the price per unit can be increased by up to five cents, to a maximum of $1.00, it would be determined at step 250 that “Yes”, the price per unit being bid in Intent I′ can be improved to exceed the price per unit bid in BBO Order BBO₂.

(However, if, for example, the price offered in BBO Order BBO₂ was $1.01, then it would be determined at step 250 that “No”, no adjustment can be made to the intent to improve over the BBO Order, and thus method 200 would advance from step 250 to step 225, at which point Order O₃ would be forwarded to trading engine 66 to be executed against the BBO Order BBO₂ in substantially the same manner as earlier described in relation to step 225.)

Assuming, however, that at step 250 it is determined that “Yes”, Intent I′ can improve the price for Order O₃, then method 200 moves from step 250 to step 255 at which point the parameters of Intent I′ are applied to provide the necessary (or otherwise desired) improvement. In particular, a trade notification TN1 will be created with the necessary improvement and provided to trading engine 66. The parameters of trade notification TN1 are shown in Table XI.

TABLE XI
Portion of trade notification TN1 extracted from Intent I′

| Field Number | Field Name | Example Contents |
|---|---|---|
| 1 | Firm | Firm F1 |
| 2 | Security Name | XYZ Co. |
| 3 | Transaction Type | Buy |
| 4 | Quantity | 5,000 units |
| 5 | Price per unit | $1.00 |

Method 200 then advances to step 240 from step 255, at which point a trade will be executed between Intent I′ and Order O₃. This step is represented in FIG. 8, as internalization processor 74 passes trade notification TN1 to trading engine 66. Table XII shows the form in which trade notification TN1 is presented to trading engine 66. Once presented to trading engine 66, trade notification TN1 is handled in the usual manner, and returned to Firm F1 in the usual manner, now allowing Firm F1 (and/or the entities that placed Intent I and Order O₂) to enjoy the benefits of an internalized trade.

TABLE XII
Information for trade at trading engine
66 regarding trade notification TN1

| Portion of trade | | | Portion of trade | | |
|---|---|---|---|---|---|
| notification TN1 | | | notification TN1 | | |
| extracted from Intent I′ | | | from Order O₃ | | |
| Field | | Example | Field | | Example |
| Number | Field Name | Contents | Number | Field Name | Contents |
| 1 | Firm | Firm F1 | 1 | Firm | Firm F1 |
| 2 | Security | XYZ Co. | 2 | Security | XYZ Co. |
| | Name | | | Name | |
| 3 | Transaction | Buy | 3 | Transaction | Sell |
| | Type | | | Type | |
| 4 | Quantity | 5,000 | 4 | Quantity | 5,000 |
| | | units | | | units |
| 5 | Price per | $1.00 | 5 | Price per | $1.00 |
| | unit | | | unit | |

Intent I′ is also now marked as filled, since the entirety of Intent I has now been fulfilled.

Thus, as method 200 advances from step 240 to step 245 during this cycle of method 200, it will be determined at step 245 that Intent I has been fulfilled, and therefore method 200 will end.

It is to be understood that in another embodiment the structure of an intent can be changed according to other desired structures. Table XIII shows an example, Intent II.

TABLE XIII
Intent I1

| Field Number | Field Name | Example Contents |
|---|---|---|
| 1 | Firm | Firm F1 |
| 2 | Security Name | CDE Co. |
| 3 | Transaction Type | Buy |
| 4 | Quantity | 1,000 units |
| 5 | Price per Unit | Market Rate |

More particularly, Fields 1 through 4 remain substantially the same as the structure of Intent I′ shown in Table 1. Field 6, the field relating to the Improvement Criterion, is however, no longer used. Instead, in this embodiment, Improvement Criterion is fixed to one cent by the operator of internalization processor 74 shown in FIG. 3. Finally, Field 5 is set to “Market Rate”, the actual value to be determined by the internalization processor 74, according to the then known market rate, at the time the intent is to be executed against a regular order.

By way of example, assume that operator of workstation 54₁ of firm F1 wishes to lodge Intent I1 for processing by internalization engine 70. Reference will now be made again to method 200 in FIG. 2 to assist in the explanation of the workings of this example. As in previous examples, beginning first at step 210, Intent II is received at internalization engine 70 which is shown in FIG. 3.

Assuming that intent II is validly received at step 210, then method 200 advances to step 215. Prior to the performance of step 215 it will be assumed that market feed 82 indicates Order BBO₃ available, shown in Table XIV.

TABLE XIV
BBO Order BBO₃

| Field Number | Field Name | Example Contents |
|---|---|---|
| 1 | Firm | Firm F3 |
| 2 | Security Name | CDE Co. |
| 3 | Transaction Type | Buy |
| 4 | Quantity | 1,000 units |
| 5 | Price per unit | $0.99 |

During this pass through step 215, it will be assumed a regular order O₄ is received. Table XV shows the structure and exemplary contents of Order O₄.

TABLE XV
Order O₄

| Field Number | Field Name | Example Contents |
|---|---|---|
| 1 | Firm | Firm F1 |
| 2 | Security Name | CDE Co. |
| 3 | Transaction Type | Sell |
| 4 | Quantity | 1,000 units |
| 5 | Price per unit | $0.99 |

Advancing to step 220, a determination is made as to whether the intent received at step 210 matches the order just received at step 215. Continuing with the specific example, such a match is made by internalization processor 74, which examines the contents of both Intent I1 and Order O₄ to see if various fields match to indicate the possibility of a internalization being effected. Table XVI reproduces Tables XIII and XV side-by-side to assist in explaining this specific example.

TABLE XVI
Comparison of Intent I1 and Order O₄

| Table XIII | | | Table XV | | |
|---|---|---|---|---|---|
| Intent I1 | | | Order O₄ | | |
| Field | | Example | Field | | Example |
| Number | Field Name | Contents | Number | Field Name | Contents |
| 1 | Firm | Firm F1 | 1 | Firm | Firm F1 |
| 2 | Security | CDE Co. | 2 | Security | CDE Co. |
| | Name | | | Name | |
| 3 | Transaction | Buy | 3 | Transaction | Sell |
| | Type | | | Type | |
| 4 | Quantity | 1,000 | 4 | Quantity | 1,000 |
| | | units | | | units |
| 5 | Price per unit | Market | 5 | Price per | $0.99 |
| | | Rate | | unit | |

Thus, at step 220, internalization processor 74 examines Intent I1 and Order O₄ for matches between Fields 1 and 2, and for complementary matches between Field 3. Since Intent II and Order O₄ both originated from Firm F1, and since the Security Name is “CDE Co.” for Intent I1 and Order O₄, and since Intent I1 is a “Buy” while Order O₄ is a “Sell”, it will be determined at step 220 that “yes”, Intent II does match Order O₃, and thus method 200 will advance to step 235.

At step 235, a determination is made as to whether matching intent I1 with Order O₄ would conflict with the outstanding BBO order BBO₃ indicated from market feed 82. Due to the existence of BBO order BBO₃, during this pass through step 235 it would be determined “yes”, a conflict does exist, in particular because the price per unit being bid in BBO order BBO₃ matches the price of Order O₄.

At this point, method 200 advances from step 235 to step 250, where a determination is made as to whether the intent can be adjusted to improve over the outstanding BBO order. Since the Improvement Criterion for Intent I1 is fixed to one cent by the operator of internalization engine 70, it would be determined at step 250 that “Yes”, the price per unit being bid in Intent I1 can be improved to exceed the price per unit bid in BBO Order BBO₃. Indeed, since the Improvement Criterion is a fixed one and the price per unit set to “market rate” with no maximum, an adjustment can always be made to an intent to improve over a BBO order. In effect, in this embodiment, the need for making a decision at step 250 is eliminated; method 200 always advances from step 235 to step 255.

Continuing with the example, method 200 moves from step 250 to step 255 at which point the parameters of Intent I1 are adjusted to provide the necessary (or otherwise desired) improvement. In particular, a trade notification TN2 will be created with the necessary improvement and provided to trading engine 66. The parameters of trade notification TN2 are shown in Table XVII.

TABLE XVII
Portion of trade notification TN2 extracted from Intent I1

| Field Number | Field Name | Example Contents |
|---|---|---|
| 1 | Firm | Firm F1 |
| 2 | Security Name | CDE Co. |
| 3 | Transaction Type | Buy |
| 4 | Quantity | 1,000 units |
| 5 | Price per unit | $1.00 |

Method 200 then advances to step 240 from step 255, at which point a trade will be executed between Intent I1 and Order O₄. Table XVIII shows the form in which trade notification TN2 is presented to trading engine 66. Once presented to trading engine 66, trade notification TN2 is handled in the usual manner, and returned to Firm F1 in the usual manner, now allowing Firm F1 (and/or the entities that placed Intent I1 and Order O₄) to enjoy the benefits of an internalized trade.

TABLE XVIII
Information for trade at trading engine
66 regarding trade notification TN2

| Portion of trade | | | Portion of trade | | |
|---|---|---|---|---|---|
| notification TN2 | | | notification TN2 | | |
| extracted from Intent I1 | | | from Order O₄ | | |
| Field | | Example | Field | | Example |
| Number | Field Name | Contents | Number | Field Name | Contents |
| 1 | Firm | Firm F1 | 1 | Firm | Firm F1 |
| 2 | Security | CDE Co. | 2 | Security | CDE Co. |
| | Name | | | Name | |
| 3 | Transaction | Buy | 3 | Transaction | Sell |
| | Type | | | Type | |
| 4 | Quantity | 1,000 | 4 | Quantity | 1,000 |
| | | units | | | units |
| 5 | Price per | $1.00 | 5 | Price per | $1.00 |
| | unit | | | unit | |

As method 200 advances from step 240 to step 245 during this cycle of method 200, it will be determined at step 245 that Intent I1 has been fulfilled, and therefore method 200 will end.

It should now be understood that, while method 200 refers to having internalization engine 70 only process a single intent I, such reference is to simplify explanation only and that when implemented internalization engine 70 will be operable to simultaneously process a plurality of intents from one or more firms. As the plurality of intents are received, priority will be given to the processing of such intents according to desired criteria. Such criteria can simply be based on time, for example, processing intents on a ‘first-in-first-out’ basis. Other criteria can include giving priority to certain workstations issuing intents priority over other workstations issuing intents within the same firm. Other prioritization criteria for processing a plurality of intents will now occur to those of skill in the art.

It should also be understood that price improvement criterion or criteria can be administered on a firm wide basis, such as by having a single authorized individual of a given firm F access internalization engine 70 to issue instructions as to what price improvement criteria will be used for all intents originating from that particular firm F. It should also be understood that, in certain embodiments, internalization engine 70 can be operable to receive instructions from a firm F to cancel or modify any outstanding intents that are waiting to be processed by internalization engine 70. Such instructions can be issued in any desired manner, such as by hosting a secure socket layer (“SSL”) web-page at engine 70 which is accessible to one or more workstations of a given firm that issued the intent being cancelled or modified,

It should be noted that if, at step 215, there was no BBO order BBO₃ available as indicated from market feed 82, then method 200 would have passed through step 240, rather than 250, since there would have been no intent to conflict with a BBO order. In that case, the Price per Unit field of Intent I1 would have been set to equal the Price per Unit field of O₄. Specifically, in this example, the Price per Unit as presented in the trade notification would have been set at $0.99, the Price per Unit specified in Field 5 of the order O₄.

In a specific implementation of system 50, internalization processor 74 is configured to examine data available from feed 82 and make determinations about matching of orders with intents in light of that feed 82 within a time frame that ensures that the quote from feed 82 remains substantially valid. It has been determined that during certain peak trading hours, typically in the first two hours after trading begins, about ninety percent of quotes from feed 82 in the Toronto Stock Exchange (“TSX”) remain valid for about five hundred milliseconds. Thus, in one embodiment, processor 74 is operable to make such a determination in less than about five hundred milliseconds. In a more presently preferred embodiment, processor 74 is operable to make such a determination in less than about four hundred milliseconds. In a still further preferred embodiment, processor 74 is operable to make such a determination in less than about one hundred milliseconds.

It should now be understood, however, that processor 74 can be configured to make determinations within any predefined time period that substantially ensures that a substantial portion of quotes remain valid within that time period. In one embodiment, the substantial portion is that greater than about ninety percent of all quotes remain valid within the predefined time period. In another embodiment, the substantial portion is that greater than about ninety-five percent of all quotes remain valid within the predefined time period. In another embodiment, the substantial portion is that greater than about 99.9 percent of all quotes remain valid within the predefined time period. Where the predefined time period appears to be approaching a desired threshold, (e.g. the time period is such that only less than about ninety percent of quotes remain valid), then it can be desired to have internalization engine 70 automatically pull itself off-line, making itself unavailable in order to reduce the likelihood of errors. Alternatively, if processor 74 is approaching or surpassing the desired threshold, then it can be desired to have internalization engine 70 send a message to the relevant firm F indicating that the validity of the quote for the internalized trade needs to be verified before the trade can be considered to be completed. Alternatively, internalization engine 70 can be provided with a ‘switch’ in which an operator of engine 70 can elect to manually pull engine 70 off-line, or place engine 70 back on-line, as according to the desires of the operator.

In order to achieve the above-mentioned parameters, internalization engine 70 is engineered to maintain a minimum (or at least a significantly reduced) latency in the time it takes to obtain the current BBO information from feed 82, and to also minimize (or at least significantly reduce) the latency in the time it takes to act upon such BBO information. (i.e. where such action is to perform all or part of method 200 or its variants). By reducing these two latencies, there can be a higher degree of confidence that the BBO information will not have changed by the time a trade notification TN reaches the trading engine 66 for validation. This can be important because if the BBO does change before the trade notification TN is validated by trading engine 66, then the internalized trade risks either being rejected by trading engine 66 (due to violations of market rules governing price improvement and time priority), or, even if the internalized trade is not rejected, there can be unnecessary cost incurred through needless price improvement of the order. If either or both of these two latencies are large, attempts to internalize trades can fail with a frequency that can reduce or impair viability of the internalization.

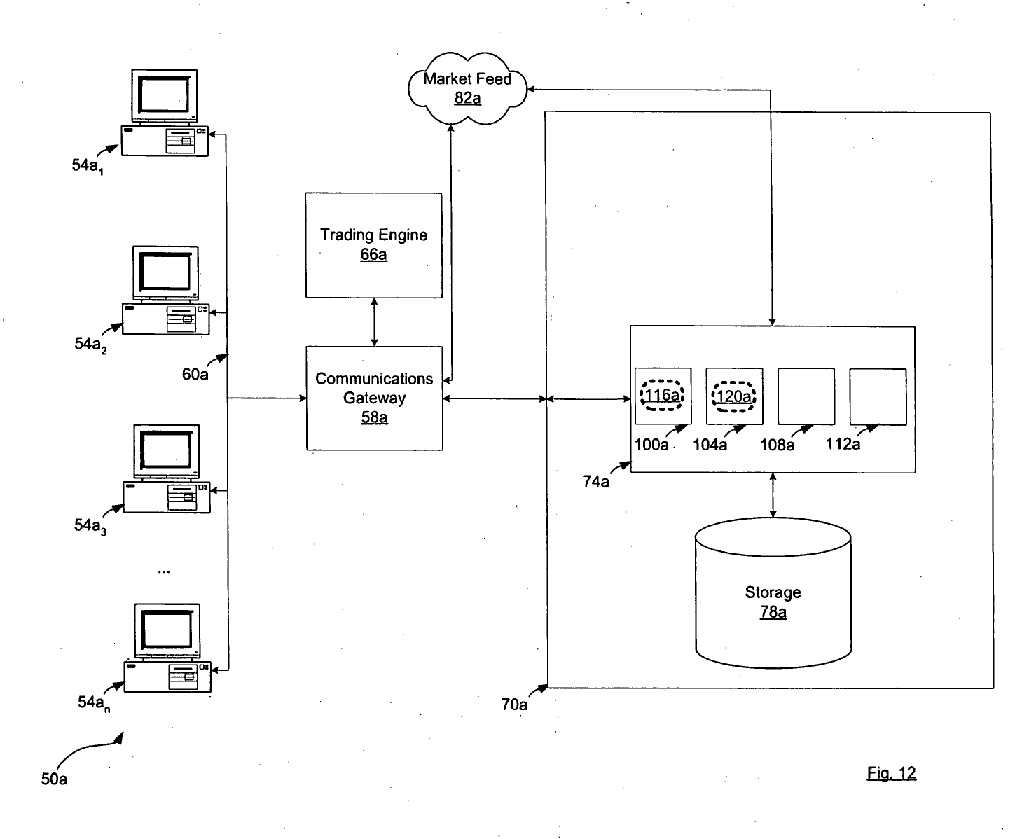

Referring now to FIG. 12, a system for executing orders in accordance with another embodiment of the invention is indicated generally at 50a. System 50a is substantially the same as system 50, and like elements in system 50a bear the same reference as like elements in system 50, except followed by the suffix “a”. In engine 70a, processor 74a is implemented using four CPUs 100a, 104a, 108a, and 112a, such as would be found in a Sun 480R. Also in engine 70a, storage 78a is implemented as a combination of random access memory (i.e. volatile memory) and hard-disc space (i.e. non-volatile memory).

A reduction in latencies referred to in the preceding paragraphs can be accomplished by implementing the business processing as two separate processes executing with internalization processor 74a. One process, referred to herein as the BBO Server executes on CPU 100a and is represented by an oval on CPU 100a indicated at 116a. BBO Server 116a receives market data feed from feed 82 and maintains the BBO prices for each stock. The second process, referred to herein as the Matching Server executes on CPU 104a and is represented by an oval on CPU 104a indicated at 120a. Matching Server 120a receives orders and intents and attempts to match them using method 200 or a suitable variation thereof.

BBO Server 116a uses the market data feed from feed 82a to build a random access memory-resident version of the order book at trading engine 66a so that BBO prices can be ascertained at any time. BBO Server 116a is furthermore multi-threaded so that one thread can be processing the market data feed from feed 82, while another independent thread services requests from the Matching Server 120a for the latest BBO price for a particular stock. BBO Server 116a works only in random access memory of engine 70a to achieve a high speed, thus maintaining a low time-latency in providing BBO prices to Matching Server 120a.

While server 116a is shown on CPU 100a, and server 120a is shown on CPU 104a, in another variation each of the threads within BBO Server 116a and Matching Server 120a can be run on different CPUs—in system 50a thereby making use of CPU 108a and CPU 112a and further improving overall processing speed. This way heavy processing demands on the one thread will not impact responsiveness on the other thread.

Matching Server 120a receives intents from traders and stores them in a table called the Intent Book (not shown in the Figures). As each order arrives, Matching Server 120a attempts to match it with an intent in the Intent Book, using method 200 or a suitable variant thereof. If a possible match is found, it issues a request for the latest BBO prices for the relevant stock (or other security) from the BBO Server 116a in order to ascertain if price improvement can be used to conform to market rules. To minimize or substantially reduce latency of this matching process, the Intent Book table is implemented in random access memory, but the Intent Book is also recoverable from persistent storage, as it is the only record of all the intents entered by the traders. To satisfy these constraints, the Intent Book table is implemented as a memory map that is transactionally backed up by persistent storage.

In general, the multiple and/or additional processing power available from CPUs 100a, 104a, 108a and 112a can be used to handle the network communications involved with receiving market data feed messages, and with exchanging orders, intents and trade notification messages. This processing can also be allocated onto another separate CPU to guard against mutual impact between this and the other two processes already described.

While only specific combinations of the various features and components of the present invention have been discussed herein, it will be apparent to those of skill in the art that desired subsets of the disclosed features and components and/or alternative combinations of these features and components can be utilized, as desired. For example, while the Improvement Criterion in Table I refers to simple price improvement, it can be understood that other types of Improvement Criteria can be offered. Such improvements could also be based on a formula that considers a ratio of commission fees associated with trades at particular volumes and or prices per unit, thus allowing for greater flexibility in how improvements are offered in order to effectively and legally improve over a BBO Order. Such improvements can also be based on improved settlement terms.

It is to be understood that while the embodiments herein discuss the handling of a single intent, it should be understood that a plurality of intents can be processed according to the desired computational capacity of the internalization engine.

It is to be understood that while internalization engine 70 is shown serving a single trading engine 66, in other embodiments internalization engine 70 can serve multiple trading engines by implementing internalization engine 70 in an application service provider (“ASP”) model on behalf of a plurality of trading engines for a plurality of different exchanges.

Embodiments herein provide a novel method and system for executing orders that allow for trade internalization. Such trade internalization can be effected external to the trading engine, and thereby avoid impairing or otherwise burdening the trading engine with the processing of internalization.

The above-described embodiments of the invention are intended to be examples of the present invention and alterations and modifications may be effected thereto, by those of skill in the art, without departing from the scope of the invention which is defined solely by the claims appended hereto.

1. A computer-based system for executing orders comprising:
a communications gateway for receiving data representing orders, at least one intent and a market feed over at least one communication connection;
a trading engine connected to said communications gateway for receiving and processing data records representing trading notifications; and,
an internalization engine having a processor connected to said gateway for receiving said data representing said orders and said at least one intent, said processor operable to perform a match of at least one of said orders with at least a portion said intent if said match accords with market rules when compared with said market feed, and, said processor further operable to deliver data representing a trading notification thereof to said trading engine via said gateway for processing.

2. The computer-based system of claim 1 wherein said processor is operable to perform said match in less than about five hundred milliseconds.

3. The computer-based system of claim 1 wherein said processor is operable to perform said match in less than about four hundred milliseconds.

4. The computer-based system of claim 1 wherein said processor is operable to perform said match in less than about one hundred milliseconds.

5. The computer-based system of claim 1 wherein said processor performs said match if said at least one of said orders originates from a firm that is the same as a firm that generated said intent.

6. The computer-based system of claim 1 wherein said processor performs said match if said at least one order of said orders originates from a different firm that is different from a firm that generated said intent.

7. The computer-based system of claim 1 wherein if said market feed includes a market feed order matchable with said order then said processor only performs said match if a price improvement can be effected to said intent in order to improve over said market feed order.

8. The computer-based system of claim 1 wherein said processor is further operable to determine whether said match can be performed within a time period such that a substantial portion of quotes from said market feed remain valid within that time period.

9. The computer-based system of claim 8 wherein said processor is further operable to decline to perform said match if said time period exceeds a threshold in which a substantial portion of said quotes do not remain valid.

10. The computer-based system of claim 8 wherein said time period is chosen such that at least about ninety percent of said quotes remain valid.

11. The computer-based system of claim 8 wherein said time period is chosen such that at least about ninety-five percent of said quotes remain valid.

12. The computer-based system of claim 8 wherein said time period is chosen such that at least about 99.9 percent of said quotes remain valid.

13. A computer-based internalization engine comprising:
an interface for connecting to a communication connection, said interface for receiving orders, at least one intent and a market feed over said communication connection;
said interface also for connecting to a trading engine that is operable to receive and processing trading notifications;
a storage device connected to said interface for storing said at least one intent; and,
an internalization processor connected to said interface and said storage device, said internalization processor operable to perform a match of at least one of said orders with at least a portion of said intent if said match accords with market rules and when compared with said market feed, said internalization engine further operable to deliver a trading notification thereof to said trading engine for processing.

14. A computer-based method of executing orders in internalization engine, said method comprising the steps of:
receiving an intent at said internalization engine and storing said intent in a storage device;
receiving a regular order at an internalization processor;
in said internalization processor, determining if at least a portion of said intent matches said regular order and;
if said regular order does not match then forwarding said regular order to a trading engine;
if said regular order does match then determining if said intent conflicts with a quote received over a market feed connected to said internalization processor and;
if said intent does not conflict with said market feed then forwarding a trade notification to said trading engine instructing said trading engine to execute a trade between said order and a relevant portion of said intent according to said match;
if said intent conflicts with said market feed then determining if said intent can be adjusted to improve over said market feed;
if said intent cannot be adjusted to improve over said market feed then forwarding said regular order to said trading engine;
if said intent can be adjusted to improve over said market feed then performing such adjustment and then forwarding a trade notification to said trading engine instructing said trading engine to execute a trade between said order and a relevant portion of said adjusted intent according to said match.

15. The method of claim 14 comprising the additional step of repeating said steps therein until said intent is fulfilled.

16. A computer-readable medium containing a set of programming instructions for a general purpose computer, said set of programming instructions including a computer-based method of executing orders in an internalization engine, said method comprising the steps of:
receiving an intent at said internalization engine and storing said intent in a storage device;
receiving a regular order at an internalization processor;
in said internalization processor, determining if at least a portion of said intent matches said regular order and;
if said regular order does not match then forwarding said regular order to a trading engine;
if said regular order does match then determining if said intent conflicts with a quote received over a market feed connected to said internalization processor and;
if said intent does not conflict with said market feed then forwarding a trade notification to said trading engine instructing said trading engine to execute a trade between said order and a relevant portion of said intent according to said match;
if said intent conflicts with said market feed then determining if said intent can be adjusted to improve over said market feed;
if said intent cannot be adjusted to improve over said market feed then forwarding said regular order to said trading engine;
if said intent can be adjusted to improve over said market feed then performing such adjustment and then forwarding a trade notification to said trading engine instructing said trading engine to execute a trade between said order and a relevant portion of said adjusted intent according to said match.
